(19) United States
(12) Patent Application Publication
(10) Pub. No.: US 2024/0093056 A1
(43) Pub. Date: Mar. 21, 2024

(54) FOG AND FROST RESISTANT COATINGS WITH LOW COEFFICIENT OF FRICTION

(71) Applicant: SDC Technologies, Inc., Irvine, CA (US)

(72) Inventors: Kiranmayi Deshpande, Irvine, CA (US); David Hess, Mission Viejo, CA (US); Ren-Zhi Jin, Irvine, CA (US); Andreas Schneider, Fullerton, CA (US)

(21) Appl. No.: 18/465,350

(22) Filed: Sep. 12, 2023

Related U.S. Application Data
(60) Provisional application No. 63/406,030, filed on Sep. 13, 2022.

(51) Int. Cl. C09D 175/08; C08J 7/054; C09D 5/00; C09D 7/20; C09D 7/63; C09D 7/65

(52) U.S. Cl. CPC C09D 175/08; C08J 7/054; C09D 5/006; C09D 7/20; C09D 7/63; C09D 7/65; C08J 2375/08

(57) ABSTRACT

A coating composition comprises a urethane resin, a water absorbent polymer, and a curing agent. The urethane resin is obtained by reaction of an isocyanate reactive compound having multi-epoxide functionality and an isocyanate. When applied to a substrate and thermally cured, the coating composition forms a transparent and smooth coating having permanent anti-fog property.

### RELATED APPLICATIONS

This application claims priority to and all benefit of U.S. Provisional Patent Application Ser. No. 63/406,030, filed on Sep. 13, 2022, for FOG AND FROST RESISTANT COATINGS WITH LOW COEFFICIENT OF FRICTION, the entire disclosure of which is incorporated herein by reference.

### FIELD

This disclosure relates to compositions for forming a coating having anti-fog and/or anti-frost properties, articles comprising such coating, and methods for making the coating and/or articles.

### BACKGROUND

Anti-fog properties are desired in applications such as ophthalmic and sun lenses; safety, military and sports eyewear and accessories; glazing for automotive, transportation, building and construction, greenhouses; industrial, point-of-sale and electronics displays; mirrors; solar panels; and others. Anti-frost properties are advantageous for low temperature applications such as freezer doors, sportswear, etc. Often times, dual functionality of anti-fog and ant-frost properties in the same coating is desired.

Fogging occurs when the water vapor from surrounding air condenses on an article forming small water droplets. This happens when the article is at a lower temperature than that of the environment, thereby cooling the surrounding air below the dew point. Current anti-fog coatings are usually hydrophilic in nature. Surfactants are used in the coating formulation to increase the surface energy of the cured coatings enabling the droplet to sheet out across the surface (i.e., wet the surface) instead of forming spherical droplets on the substrate. The resulting water sheeting effect minimizes the scattering of light thereby improving visibility.

Frosting happens when the surface of the article is below the freezing point of water. Water condensate in this scenario freezes on the article. Often it is desirable for coatings to have both anti-fog and anti-frost properties. For example, in articles such as ski goggles, heat emanating from the skier's body causes fog on the inner side of the ski goggle. As such, anti-fog property is important for the inner side of the ski goggle. However, on the outer side of the ski goggle, exposed to the cold, snowy environment, anti-frost property is required. Thus, a coating which can function as both anti-fogging and anti-frosting is important.

In order to have long-lasting, or permanent, anti-fog performance, anti-fog coatings are typically formulated with large amounts of surfactants in combination with hydrophilic networks. These high loadings of surfactants, and the hydrophilic networks often make the cured coatings not so smooth to touch. As a result, the articles coated with anti-fog coatings are not so easy to handle and clean. High loadings of the surfactants also leave the coatings susceptible to bag mark off when packaged in poor quality bags.

Resistance to fogging and resistance to surface damage by fine particles are essential criteria for eye wear to be considered as personal protection equipment. Furthermore, personal protective eyewear is ideally required to pass European Standard EN 166 (e.g., EN 166, rev. 2001) to obtain certification. EN 166 includes several tests for different safety requirements, namely, stability to elevated temperatures, resistance to ultraviolet radiation, corrosion, ignition, fogging, surface damage by large particles/fine particles, etc. Test methods included in EN 166 certification are EN 167, which includes optical test methods, and EN 168, which includes non-optical test methods. Resistance to fogging of the oculars (referred to as “N-mark”) and resistance to surface damage by fine particles (referred to as “K-mark”) are included in EN 168. Thus, the eye wear with cured coatings that offer resistance to fog and pass tests specified in EN 168 are considered to have EN 166 N-mark. Similarly, the eye wear with cured coatings which pass EN 168 tests for resistance to surface damage by fine particles are considered to have EN 166 K-mark.

### SUMMARY

The present disclosure provides a coating composition comprising a urethane resin, a water absorbent polymer, and a curing agent. The urethane resin is obtained by reaction of an isocyanate reactive compound having multi-epoxide functionality and an isocyanate. When applied to a substrate and thermally cured, the coating composition forms a transparent and smooth coating having permanent anti-fog property.

In addition, an article comprising a substrate, and a transparent, smooth, and permanent anti-fog coating applied onto the substrate, is described in the present disclosure. The coating is formed from a coating composition comprising a urethane resin, a water absorbent polymer, a curing agent, a dispersing agent, and a solvent. The urethane resin is a reaction product of an isocyanate reactive compound having multi-epoxide functionality and an isocyanate.

In some aspects of the present disclosure, when applied to a substrate and thermally cured, the coating composition forms a transparent and smooth coating having anti-frost property in addition to permanent anti-fog property. The present disclosure also describes an article comprising a transparent and smooth coating having permanent anti-fog property and anti-frost property applied onto a substrate.

### DETAILED DESCRIPTION

A coating composition is described in the present disclosure. The multi-part composition comprises a urethane resin, a water absorbent polymer, and a curing agent. The urethane resin is obtained by reaction of an isocyanate reactive compound having multi-epoxide functionality and an isocyanate. When applied to a substrate and thermally cured, the coating composition forms a transparent and smooth coating having permanent anti-fog property. The coating composition may further comprise a dispersing agent and a solvent.

In addition, an article is described in the present disclosure. The article comprises a substrate, and a transparent and smooth anti-fog coating applied onto the substrate. The coating is formed from the coating composition disclosed herein.

Due to the intrinsic nature of the hydrophilic, surfactant rich systems, anti-fog coatings tend to have grabby/tacky surface feel. As a result, they sometimes stick to the packaging material, such as high density polyethylene (HDPE), low density polyethylene (LDPE), cast unoriented polypropylene (CPP), chlorinated polyethylene (CPE), polypropylene (PP), polyethylene (PE), etc., and leave a mark on the coated article. A coated article with smooth (non-tacky/grabby) surface makes it easier to slip in and out of various packaging formed from such material. Also, since the anti-fog and anti-frost coatings are often used for eyewear, end user often does not like the grabby feel when cleaning the lenses or goggles with a cloth. Thus, smooth surface feel for the anti-fog and anti-frost coatings is highly desired.

The coating composition of the present disclosure provides an article, such as an eyewear, with coatings having long-lasting anti-fog and/or anti-frost properties and smooth/slick surface feel, which are achieved by combination of the water absorbent polymer and hydrophilic network of the urethane resin with crosslinked epoxide groups. The coatings facilitate easy handling, cleaning, and packaging. Additionally, the coatings may render the article resistant to damage by fine particles.

### Urethane Resin

As discussed above, the coating composition comprises a urethane resin obtained by reaction of an isocyanate reactive compound having multi-epoxide functionality and an isocyanate. When the coating composition is applied to an article, the resulting network provides long term adhesion to the substrate.

The isocyanate reactive compound having multi-epoxide functionality comprises at least two epoxide groups. In accordance with the present disclosure, the isocyanate reactive compound having multi-epoxide functionality may comprise three or more epoxide groups. The epoxide groups, upon cure, further contribute to the hydrophilicity, and thus the permanent anti-fog properties of the coating.

The isocyanate reactive compound having multi-epoxide functionality comprises at least one isocyanate reactive group. In accordance with the present disclosure, the isocyanate reactive compound having multi-epoxide functionality may include at least one hydroxyl group as the isocyanate reactive group.

In accordance with the present disclosure, the isocyanate reactive compound having multi-epoxide functionality may be ethoxylated and/or propoxylated. In some aspects of the present disclosure, optimal anti-fog properties are achieved with an isocyanate reactive compound having multi-epoxide functionality includes at least one ethyleneoxy and/or propylenoxy chain and at least one hydroxyl group.

The isocyanate reactive compound having multi-epoxide functionality may contain a silicon atom, or may be non-silicon containing.

Suitable isocyanate reactive compounds having multi-epoxide functionality that may be used include, but are not limited to, aromatic polyepoxides, aliphatic polyepoxides particularly polyfunctional aliphatic polyepoxides, glycerol polyglycidyl ethers, polyglycerol polyglycidyl ethers, sorbitol polyglycidyl ethers, ethylene glycol diglycidyl ether, diethylene glycol diglycidyl ether, polyethylene glycol diglycidyl ether, polypropylene glycol diglycidyl ether, phenoxy (ethylene oxide)₅ glycidyl ether, and lauryloxy (ethylene oxide)₁₅ glycidyl ether, or a combination thereof. Examples of commercially available polyfunctional aliphatic polyepoxides include: aliphatic polyepoxide (Denacol EX-1610), glycerol polyglycidyl ether (Denacol EX-313), polyglycerol polyglycidyl ether (Denacol EX-512 and EX-521), sorbitol polyglycidyl ether (Denacol EX-614B), ethylene glycol diglycidyl ether (Denacol EX-810 and EX-811), diethylene glycol diglycidyl ether (Denacol EX-850 and EX-851), polyethylene glycol diglycidyl ethers (Denacol EX-821, EX-830, EX-832, EX-841, and EX-861), polypropylene glycol diglycidyl ether (Denacol EX-920), phenoxy (ethylene oxide)₅ glycidyl ether (Denacol EX-145), and lauryloxy (ethylene oxide)₁₅ glycidyl ether (Denacol EX-171). All the mentioned commercial products are manufactured by Nagase ChemteX Corporation. Similar resins are also available with other vendors.

The urethane resin disclosed herein may be present in the coating composition in an amount of, for example, 1-95% by weight, including 20-90% by weight, 35-85% by weight, and 50-80% by weight based on the total solid content of the coating composition.

The isocyanate reactive compound having multi-epoxide functionality disclosed herein may be present in the coating composition in an amount of, for example, 0.5-90% by weight, including 8-70% by weight, 8-65% by weight, 10-60% by weight, 20-50% by weight, and 30-40% by weight based on the total solid content of the coating composition.

The isocyanate comprises a silicon containing isocyanate, a non-silicon containing isocyanate, or a combination thereof. The silicon containing isocyanate may have a general structure of NCO(R)Si(OR¹)₃, NCO(R)Si(OR¹)₂R³, NCO(R)Si(OR¹)(R³)₂, or a combination thereof, where R=(CH₂)ₙ, n=1-6, R¹=CH₃ or C₂H₅, and R³=CₓH₂ₓ₊₁, x=1-4. In some aspects of the present disclosure, the silicon containing isocyanate may comprise a polyisocyanate (i.e., have an isocyanate functionality greater than 1). Suitable silicon containing isocyanates that may be used include, but are not limited to, 3-isocyantopropyl triethoxysilane, 3-isocyanatopropyl trimethoxysilane, 2-isocyanatoethyl trimethoxysilane, 2-isocyanatoethyl triethoxysilane, 3-isocyanatopropyl methyldimethoxysilane, 2-isocyanatoethyl methyldimethoxysilane, 3-isocyanatopropyl methyldiethoxysilane, 2-isocyanatoethyl methyldiethoxysilane, 4-isocyanatobutyl trimethoxysilane, 4-isocyanatobutyl triethoxysilane, 5-isocyanatopentyl trimethoxysilane, 5-isocyanatopentyl triethoxysilane, 6-isocyanatohexyl trimethoxysilane, 6-isocyanatohexyl triethoxysilane, or a combination thereof.

In accordance with the present disclosure, at least one silicon containing isocyanate may be a reactive isocyanate alkoxysilane. In such aspects, the alkoxy groups of the urethane resin obtained by reaction of the isocyanate reactive compound having multi-epoxide functionality and the reactive isocyanate alkoxysilane may be further hydrolyzed, for example by water and acid.

As discussed above, the isocyanate may comprise a non-silicon containing isocyanate. The non-silicon containing isocyanate may comprise a polyisocyanate (i.e., have an isocyanate functionality greater than 1). In some aspects of the present disclosure, aliphatic polyisocyanates, including but not limited to aliphatic diisocyanates and aliphatic triisocyanates, are preferred because of their better light stability than aromatic polyisocyanates. Suitable non-silicon containing isocyanates having an isocyanate functionality greater than 1 that may be used include, but are not limited to, isophorone diisocyanate (IPDI), hexamethylene diisocyanate (HDI), xylene diisocyanate (XDI), toluene diisocyanate (TDI), diphenylmethane diisocyanate, HDI biuret, a diisocyanate derived from the foregoing, or a combination thereof. Commercially available examples of such non-silicon containing polyisocyanates include Desmodur I, Desmodur N75, and Desmodur W. In some aspects of the present disclosure, the non-silicon containing isocyanate comprises a monoisocyanate (i.e., have an isocyanate functionality of 1).

The isocyanate disclosed herein may be present in the coating composition in an amount of, for example, 0.1-40% by weight, including 10-37% by weight, 20-33% by weight, and 25-30% by weight based on the total solid content of the coating composition.

### Water Absorbent Polymer

As discussed above, the coating composition comprises a water absorbent polymer. The water absorbent polymer absorbs the water condensate as it forms on the surface of cured coating, further enhancing the permanent anti-fog properties. The water absorbent polymer also facilitates the anti-frost property.

In accordance with the present disclosure, the water absorbent polymer may include, but is not limited to, polyvinylpyrrolidone, poly (vinylpyrrolidone-co-vinyl acetate), poly (vinylpyrrolidone-co-ethylacrylate), poly (vinyl-pyrrolidone-co-vinyl chloride), polyvinylalcohols, sulphonates esters, polyacrylic acid, or a combination thereof.

The water absorbent polymer disclosed herein may be present in the coating composition in an amount of, for example, 0.01-50% by weight, including 0.01-40% by weight, 5-38% by weight, and 20-35% by weight based on the total solid content of the coating composition.

### Curing Agent

As discussed above, the coating composition comprises a curing agent. The curing agent can be any substance that causes the crosslinking of the isocyanate reactive compound having multi-epoxide functionality. In accordance with the present disclosure, the curing agent may be an amine, an amine salt, or a combination thereof, including for example aliphatic/aromatic/modified amines, tertiary or secondary amines, immadazoles, polymercaptans, etc. Examples of suitable specific curing agents that may be used include, but are not limited to, Three Bond 2000 series (2103, 2163, 2162F, 2163C, 2086B etc.), tris-(dimethylaminomethyl)phenol tri (2-ethyl hexoate), tris-(dimethylaminomethyl) phenol, diazabicyclo-undecene, borontrifluoride amine complex, or a combination thereof. Lewis acid base adducts, such as borontrifluoride amine complex, may also be used as the curing agent.

The curing agent disclosed herein may be present in the coating composition in an amount of, for example, 0.1-2% by weight, including 0.3-1.5% by weight, 0.5-1% by weight, and 0.6-0.7% by weight based on the total solid content of the coating composition.

### Solvent

The coating composition may comprise a solvent. The solvent includes one or more solvents compatible with the urethane resin, for example, water, organic solvents, and combinations thereof. The organic solvents may be selected to provide good solubility of the isocyanate reactive compound having multi-epoxide functionality, the isocyanate, and the water absorbent polymer. Suitable organic solvents that may be used include, but are not limited to, ketones such as methylethylketone, methylisobutyl ketone, diacetone alcohol, 3,3-dimethyl-2-butanone, and pentanedione; esters; glycol esters; primary, secondary, and tertiary alcohols; polar aprotic solvents such as acetonitrile, N-methyl-2-pyrrolidone, dimethylformamide, dimethylsulfoxide, and ethers such as 1,2 dimethoxyethane and PM glycol ether.

The solvent disclosed herein may be present in the coating composition in an amount such that the total solid content of the coating composition is, for example, 5-75% by weight, including 10-45% by weight, 15-40% by weight, and 20-35% by weight.

### Dispersing Agent

The coating composition may further comprise a dispersing agent. The dispersing agent may enhance the solubility of the urethane resin or other polymers such as the water absorbent polymer, particularly in aqueous-organic solvent mixes. The enhanced solubility of the components allows them to be included in higher amounts in the coating composition while maintaining good stability and applicability of the coating composition. In some aspects of the present disclosure, the dispersing agent allows a higher amount of the water absorbent polymer to be included in the coating composition, which in turn improves the anti-fog and/or anti-frost property of the coating formed.

In accordance with the present disclosure, the dispersing agent may be a polymeric dispersing agent with hydrophilic and hydrophobic segments. Suitable commercially available dispersing agents that may be used include, but are not limited to, Disperbyk 2013, Disperbyk 161, Solsperse W100, Solsperse W150, Solsperse W430, or a combination thereof.

The dispersing agent disclosed herein may be present in the coating composition in an amount of, for example, 0-10% by weight, including 0.1-5% by weight, 0.1-1% by weight, and 0.2-0.75% by weight based on the total solid content of the coating composition.

### Additional Aspects

The coating composition may further comprise one or more optional components as described below. The one or more optional components may be present in the coating composition in an amount of, for example, 0-20% by weight, including 1-10% by weight, 2-8% by weight, and 3-6% by weight based on the total solid content of the coating composition.

The coating composition may further comprise a flow modifier, also known in the art as leveling agent or flow-control agent. The flow modifier may help spread the coating composition evenly or level on the surface of the substrate to provide substantially uniform contact with the substrate. The flow modifier can be selected from any conventional flow modifiers or leveling agents compatible with the coating composition and the substrate. Suitable flow modifiers that may be used include, but are not limited to, polyethers, silicones, fluorosurfactants, polyacrylates, silicone polyacrylates such as silicone hexaacrylate, fluoro-modified polyacrylates, or a combination thereof. Examples of commercially available flow modifiers include BYK 333, BYK 350, BYK 354, BYK 356, BYK 3420, Capstone FS-35, Capstone FS-31, Capstone FS-61, TRITON X-100, X-405, and N-57 from Rohm and Haas, Paint Additive 3, Paint Additive 29, and Paint Additive 57 (silicones) from Dow Corning, SILWET L-77 and SILWET L-7600 from Momentive (Columbus, OH), FLUORAD FC-4430 (fluorosurfactant) from 3M Corporation (St. Paul, MN), Tegomer E-Si2330 from Evonik, and KF-1002, X-22-3939A, X-22-4741, and KP-301 from Shin Etsu. The flow modifier disclosed herein may be present in the coating composition in an amount of, for example, 0-20% by weight, including 1-10% by weight, 2-8% by weight, and 3-6% by weight based on the total solid content of the coating composition.

The coating composition may further comprise a non-reactive surfactant. In a fog causing environment, non-reactive surfactants quickly rise to the surface and cause water sheeting, preventing fog formation. The non-reactive surfactant does not bond and form part of the network. Instead, they are associated with the network possibly by weak van der Waals or hydrogen bonds. Suitable non-reactive surfactants that may be used include, but are not limited to, sodium dioctyl sulfosuccinate, sodium bistridecyl sulfo succinate, sodium dihexyl sulfosuccinate, sodium dicyclohexyl sulfosuccinate, sodium diamylsulfosuccinate, sodium diisobutyl sulfo succinate, alkylamine-guanidine polyoxyethanol, or a combination thereof. The non-reactive surfactant disclosed herein may be present in the coating composition in an amount of, for example, 0-20% by weight, including 1-20% by weight, 1-15% by weight, and 6-11% by weight based on the total solid content of the coating composition.

The coating composition may further comprise a UV absorber for inhibiting the degradation of the substrate material (e.g., aromatic plastic such as polycarbonate) under the exposure of UV light, or weathering. Suitable UV absorbers that may be used include, but are not limited to, 1) 2-hydroxy-benzophenones (BP) derivatives, commercial examples include Chimassorb® 81 and Chimassorb® 90 (both from BASF, Germany); 2) 2-(2-hydroxyphenyl)-benzotriazole (HPBT) derivatives, commercial examples include Tinuvin® 1130, Tinuvin® 384-2, Tinuvin® 928, and Tinuvin® 900 (all from BASF, Germany); 3) 2-hydroxyphenyl-s-triazines (HPT) derivatives, commercial examples include Tinuvin® 400 and Tinuvin® 405 (both from BASF, Germany).

The coating composition may further comprise a hindered amine light stabilizer (HALS) for stabilization against the detrimental effects of light and weathering. Suitable HALS that may be used include, but are not limited to, derivatives of 2,2,6,6-tetramethyl piperidine. Commercial examples include Tinuvin® 152 and Tinuvin® 292 (both from BASF, Germany).

The coating composition may further comprise one or more additives for improving abrasion resistance of the coatings, for example, metal oxide nanoparticles and hydrolysis and condensation products of alkoxysiloxanes. Suitable examples of metal oxide nanoparticles include, but are not limited to, silica particles, titania, alumina, zinc oxides, antimony oxide, tin oxide, zirconium oxides, and combinations thereof. The size and concentration of the metal nanoparticles can be selected such that the resulting coatings are optically transparent, while still retaining their anti-fog properties and wear resistant properties. In some aspects of the present disclosure, the coating composition comprises metal oxide nanoparticles with sizes ranging from 5 to 50 nm, including 7 to 40 nm, 9 to 30 nm, and 10 to 20 nm.

The coating composition may further comprise one or more additives selected from antioxidant, antistatic agent, weather resistive agent, tint additive, UV stabilizer, defoamer, heat stabilizer, and surface modifying agents. Examples of antioxidants include octadecyl-3-(3,5-di-tertbutyl-4-hydroxyphenyl) propionate, and pentaerythrityltetrakis[3-(3,5-di-tert-butyl-4-hydroxyphenyl)propionate]. Examples of heat stabilizers include triphenyl phosphite, tris-(2,6 dimethylphenyl)phosphite, tris-(2,4-di-t-butyl-phenyl)phosphite, tris-(mixed mono- and di-nonylphenyl)phosphite, dimethylbenzene phosphonate and trimethyl phosphate. Examples of antistatic agents include glycerolmonostearate, sodium stearyl sulfonate, and sodium dodecylbenzenesulfonate.

### Article

As discussed above, an article is described in the present disclosure. The article comprises a substrate, and a transparent and smooth anti-fog coating applied onto the substrate. The substrate can be rigid or flexible substrates. Suitable substrate materials include, but are not limited to, transparent plastics such as polycarbonate (PC), polarized polycarbonate, polyamide, polyacrylic, polymethylmethacrylate (PMMA), polyvinylchloride, polybisallyl carbonate, allyl diglycol carbonate (ADC) polymer, polyethylene terephthalate (PET), polyethylene naphthenate, cellulose triacetate (CTA) polymer, cellulose acetate butyrate (CAB) polymer, polyurethane, polyepisulfide, and polythiourethane; various polyolefins, fluorinated polymers, metals, and glass such as soda-lime glass, borosilicate glass, and acrylic glass among other types of glass.

The transparent and smooth anti-fog coating is formed from the coating composition disclosed herein. The coating composition can be applied in any suitable manner to the substrate, for example, by conventional methods such as flow coating, spray coating, curtain coating, dip coating, spin coating, slot-die coating, roll coating, and the like, to form a continuous surface film on the substrate. The coating composition is then cured in accordance with the combination of the isocyanate reactive compound having multi-epoxide functionality and the curing agent, for example, by exposing the coated substrate to heat. The heat source may be conventional oven, convectional oven, or IR oven. In some aspects of the present disclosure, heat is applied to achieve a temperature of 50 to 150° C. for 10 minutes to 4 hours, including from 100 to 125° C. for 10 minutes to 2 hours.

Upon cure of the coating composition, generally, a hydrophilic polymeric network within the coating (e.g., polyether-polyurethane network) is formed. This network further forms an interpenetrating network with the water absorbent polymer. Combination of the water absorbent polymer and the polymeric network in the coating provides permanent anti-fog properties. In some aspects of the present disclosure, the coating further has anti-frost property in addition to the permanent anti-fog properties.

Appropriate pretreatments can be made to the substrate, if necessary. For example, to increase adhesion of the coating composition to the substrate, the substrate may be subjected to surface treatments and/or coated with primers, such as acrylate-based primers (particularly with PMMA substrates) and polyurethane dispersion (PUD) based primers.

Examples of the article include, but are not limited to, safety eyewear; optical lenses; goggles; face shields; face plates for helmets; glazing used as windows in buildings, and glazing used as windshields or windows in automobiles, buses, trains, airplanes, and other transportation vehicles; multifunctional LED or LCD displays; bathroom mirrors; and shower mirrors and fixtures. Other examples include commercial freezer doors, ice cream freezer doors, and deli cases. In accordance with the present disclosure, the coating formed from the coating composition may be compatible with anti-reflective coating or mirror coating.

The coating composition can be coated and cured on thin flexible substrates such as PC or PET film, which are then installed or retrofitted via dry or wet lamination on rigid substrates. Thin flexible substrates applied with the coating can also be mounted/applied to articles that require anti-fog functionality, for example, safety eyewear, optical lenses, goggles, face shields, face plates for helmets, glazing used as windows in buildings, glazing used as windshields or windows in automotives, buses, trains, airplanes, and other transportation vehicles, multifunctional LED, LCD displays, and bathroom and shower mirrors.

### Properties of the Coating

When applied to a substrate and cured, the coating composition forms a transparent and smooth coating having permanent anti-fog property. In accordance with the present disclosure, “smooth” is defined as having a low coefficient of friction, including lower than 0.37, including between 0.05 to 0.35, between 0.1 to 0.29, between 0.15 to 0.25, and between 0.18 to 0.22. In accordance with the present disclosure, the coating may have long lasting smoothness, which means that after soaking for 7 hours in deionized water, the coating retains a coefficient of friction lower than 0.37, including between 0.05 to 0.35, between 0.1 to 0.29, between 0.15 to 0.25, and between 0.18 to 0.22.

In accordance with the present disclosure, “permanent anti-fog property” means that when a coated substrate is soaked in water for at least 1 hour (e.g., 1 hour, or 2 hours), equilibrated at 25° C., 50% RH for at least 12 hours, and exposed to vapor from 50° C. water, it stays fog-free for at least 8 seconds.

In accordance with the present disclosure, the coating composition may form a coating having anti-frost property. In accordance with the present disclosure, “anti-frost property” means that when a coated substrate is placed at −18° C. for 1 hour, and then at 20±5° C. and 30-50% RH, no frost forms on the coating.

In accordance with the present disclosure, the coating composition may form a coating having wipeable anti-fog property. In accordance with the present disclosure, “wipeable anti-fog property” means that when a coated substrate is wiped for 10 cycles with a wet lint-free cleanroom wipe under 100 g weight for 5 strokes in each cycle, and exposed to vapor from 60° C. water, it stays fog-free for at least 10 seconds. In accordance with the present disclosure, the coating composition may form a coating that stays fog-free after being wiped for 15 cycles.

In accordance with the present disclosure, the coating composition may form a coating having abrasion resistance to fine particles under EN166/EN168 protocol, where the coating passes the K-mark test.

### Examples

The following examples are merely representative and should not be used to limit the scope of the present disclosure. A large variety of alternative designs exists for the methods and compositions disclosed in the examples. The selected examples are therefore used mostly to demonstrate the principles of the compositions and methods disclosed herein.

### Generic Description of Chemicals Used:

| Commercial Name | Generic Description |
|---|---|
| Denacol EX-614B | Multifunctional aliphatic epoxy compound based on sorbitol |
| | polyglycidyl ether |
| Denacol EX-521 | Multifunctional aliphatic epoxy compound based on |
| | polyglycerol polyglycidyl ether |
| Denacol EX-830 | Difunctional aliphatic epoxy compound based on polyethylene |
| | glycol diglycidyl ether |
| Silquest A link25 | 3-Isocyanatopropyltriethoxysilane |
| Desmodur I | Isophorone Diisocyanate (IPDI) |
| PVP - K17 | Polyvinyl pyrrolidone K90 (molecular weight, 16000 D) |
| PVP - K90 | Polyvinyl pyrrolidone K90 (molecular weight 1,300,000 D) |
| PVP - K120 | Polyvinyl pyrrolidone K90 ( molecular weight 3 million D) |
| Nalco 1034 | Colloidal Silica in water, mean particle size 20 nm, pH 3.1 |
| PEG-600 | Polyethylene Glycol 600 |
| Fomrez UL-22 | Dimethyl tin mercaptide |
| Ancamine K61B | Tris-(dimethylaminomethyl) phenol tri(2-ethyl hexoate)-an |
| | amine salt |
| Aerosol OT-75 | Sodium Dioctyl Sulfosuccinate. |
| Schercoquat IAS-PG | Quaternary compound of an isostearic substituted amidoamine |
| Solsperse W100 | 40% Polymeric dispersant in water |
| Byk 333 | Silicone additve |
| Tegomer E-Si2330 | Epoxy-functional polydimethylsiloxane. |
| Capstone FS61 | Water-based, anionic fluorosurfactant |
| Disperbyk 161 | High molecular weight wetting and dispersing additive |
| Disperbyk 2013 | Solvent free wetting and dispersing additive |
| Solsperse W430 | 50% Polymeric dispersant in water |

Example 1: 138.4 g of Denacol EX-614B (aliphatic epoxy compound based on sorbitol polyglycidyl ether), 61.58 g Silquest Alink25 (3-Isocyanatopropyltriethoxysilane) are weighed out in a round bottom flask and mixed until homogeneous. Mixture is placed in a water bath at 70° C. While continuously stirring, 0.05 g of Fomrez UL-22 catalyst was added. Reaction was carried out for 2 hours.

Example 1A: 109.8 g of Denacol EX-521, 20.52 g Silquest Alink25 (3-Isocyanatopropyltriethoxysilane) are weighed out in a round bottom flask and mixed until homogeneous. Mixture is placed in a water bath at 70° C. While continuously stirring, 0.05 g of Fomrez UL-22 catalyst was added. Reaction was carried out for 2 hours.

Example 2: To 115.3 g of Denacol Ex-614B, 16.6 g of diacetone alcohol, and 55.5 g of isophorone diisocyanate were added. Mixture was stirred until homogenous. Mixture was then placed in a water bath at 70° C. while continuing the stirring. 0.05 g of Fomrez UL-22 was added to the mix. After 2 hours of reaction, 51 g of PM glycol ether was added. Reaction was continued for another 2 hours.

Example 3: 4 g of Polyvinylpyrrolidone K90, 0.08 g Solsperse W100, 76.53 g PM glycol ether were weighed out into a container and mixed for 1 hour until a homogeneous mixture was obtained. To this, 14.8 g of example 1, followed by 1.25 g Nalco 1034 silica sol was added while mixing. 0.64 g water, 0.68 g glacial acetic acid, 0.17 g of Ancamine K61B, 1.33 g Aerosol OT75, 0.38 g Schercoquat IAS-PG, 0.11 g of 10% Byk 333 in PM glycol ether were also added. Mixing was continued for about 12 hours.

Example 4: 4 g of Polyvinylpyrrolidone K90, 0.08 g Solsperse W100, 75.88 g PM glycol ether were weighed out into a container and mixed for 1 hour until a homogeneous mixture was obtained. To this, 16 g of example 1 was added while mixing. 1.29 g water, 0.67 g glacial acetic acid, 0.17 g of Ancamine K61B, 1.33 g Aerosol OT75, 0.38 g Schercoquat IAS-PG, 0.2 g of 10% Byk 333 in PM glycol ether were also added. Mixing was continued for about 12 hours.

Example 5: 4.9 g of Polyvinylpyrrolidone K90, 0.08 g Solsperse W100, 76.38 g PM glycol ether were weighed out into a container and mixed for 1 hour until a homogeneous mixture was obtained. To this, 14.9 g of example 1 was added while mixing. 1.2 g water, 0.63 g glacial acetic acid, 0.16 g Ancamine K61B, 1.25 g Aerosol OT75, 0.35 g Schercoquat IAS-PG, 0.15 g of 1% Tegomer E-Si2330 in PM glycol ether were also added. Mixing was continued for about 12 h.

Example 6: 4.9 g Polyvinylpyrrolidone K90, 0.08 g Solsperse W100, 76.48 g PM glycol ether were weighed out into a container and mixed for 1 hour until a homogeneous mixture was obtained. To this, 14.9 g of example 1 was added while mixing. 1.2 g water, 0.63 g glacial acetic acid, 0.16 g Ancamine K61B, 1.25 g Aerosol OT75, 0.35 g Schercoquat IAS-PG, 0.05 g of 10% Byk-333 in PM glycol ether were also added. Mixing was continued for about 12 h.

Example 7: 5.62 g of Polyvinylpyrrolidone K90, 0.09 g Solsperse W100, 75.73 g PM glycol ether were weighed out into a container and mixed for 1 hour until a homogeneous mixture was obtained. To this, 14.74 g of example 1 was added while mixing. 1.18 g water, 0.62 g glacial acetic acid, 0.15 g Ancamine K61B, 1.34 g Aerosol OT75, 0.38 g Schercoquat IAS-PG, 0.15 g of 1% Tegomer E-Si2330 in PM glycol ether were also added. Mixing was continued for about 12 hours.

Example 8: 8.02 g Polyvinylpyrrolidone K90, 0.13 g Solsperse W100, 73.29 g PM glycol ether were weighed out into a container and mixed for 1 h until a homogeneous mixture was obtained. To this, 14.74 g of example 1 was added while mixing. 1.18 g water, 0.62 g glacial acetic acid, 0.15 g of Ancamine K61B, 1.34 g Aerosol OT75, 0.38 g Schercoquat IAS-PG, 0.15 g of 1% Tegomer E-Si2330 in PM glycol ether were also added. Mixing was continued for about 12 hours.

Example 9: 4.8 g Polyvinylpyrrolidone K90, 0.08 g Solsperse W100, 74.99 g PM glycol ether were weighed out into a container and mixed for 1 hour until a homogeneous mixture was obtained. To this, 16 g of example 2 was added while mixing. 1.29 g water, 0.67 g glacial acetic acid, 0.17 g Ancamine K61B, 1.48 g Aerosol OT75, 0.42 g Schercoquat IAS-PG, 0.1 g of 1% Tegomer E-Si2330 in PM glycol ether were also added. Mixing was continued for about 12 hours.

Example 10: 4.8 g Polyvinylpyrrolidone K90, 0.08 g Solsperse W100, 74.99 g PM glycol ether were weighed out into a container and mixed for 1 hour until a homogeneous mixture was obtained. To this, 16 g of example 2 was added while mixing. 1.29 g water, 0.67 g glacial acetic acid, 0.17 g Ancamine K61B, 1.48 g Aerosol OT75, 0.42 g Schercoquat IAS-PG, 0.1 g of 10% Byk 333 in PM glycol ether were also added. Mixing was continued for about 12 hours.

Example 11: 6.4 g Polyvinylpyrrolidone K90, 0.1 g Solsperse W100, 73.37 g PM glycol ether were weighed out into a container and mixed for 1 hour until a homogeneous mixture was obtained. To this, 16 g of example 2 was added while mixing. 1.29 g water, 0.67 g glacial acetic acid, 0.17 g Ancamine K61B, 1.48 g Aerosol OT75, 0.42 g Schercoquat IAS-PG, 0.1 g of 10% Byk 333 in PM glycol ether were also added. Mixing was continued for about 12 hours.

Example 12: 5.59 g Polyvinylpyrrolidone K90, 0.08 g Solsperse W100, 74.24 g PM glycol ether were weighed out into a container and mixed for 1 hour until a homogeneous mixture was obtained. To this, 16 g of example 1A was added while mixing. 1.28 g water, 0.67 g glacial acetic acid, 0.17 g Ancamine K61B, 1.34 g Aerosol OT75, 0.38 g Schercoquat IAS-PG, 0.02 g of 10% Byk 333 in PM glycol ether, 0.23 g of 10% Capstone FS61 in PM glycol ether were also added. Mixing was continued for about 12 hours.

Example 13: 3.9 g Polyvinylpyrrolidone K90, 0.08 g Solsperse W100, 75.93 g PM glycol ether were weighed out into a container and mixed for 1 hour until a homogeneous mixture was obtained. To this, 16 g of example 1A was added while mixing. 1.28 g water, 0.67 g glacial acetic acid, 0.17 g of Ancamine K61B, 1.34 g Aerosol OT75, 0.38 g Schercoquat IAS-PG, 0.02 g of 10% Byk 333 in PM glycol ether, 0.23 g of 10% Capstone FS61 in PM glycol ether were also added. Mixing was continued for about 12 hours.

Example 14: 4.08 g Polyvinylpyrrolidone K120, 0.96 g Solsperse W100, 76.02 g PM glycol ether were weighed out into a container and mixed for 1 hour until a homogeneous mixture was obtained. To this, 15.04 g of example 2 was added while mixing. 1.2 g water, 0.63 g glacial acetic acid, 0.2 g Ancamine K61B, 1.34 g Aerosol OT75, 0.38 g Schercoquat IAS-PG, 0.15 g of 1% Tegomer E-Si2330 in PM glycol ether were also added. Mixing was continued for about 12 hours.

Example 15: 2 g Polyvinylpyrrolidone K90, 0.08 g Solsperse W100, 71.47 g PM glycol ether were weighed out into a container and mixed for 1 hour until a homogeneous mixture was obtained. To this, 22.51 g of example 2 was added while mixing. 1.28 g water, 0.67 g glacial acetic acid, 0.17 g Ancamine K61B, 1.34 g Aerosol OT75, 0.38 g Schercoquat IAS-PG, 0.1 g of 1% Tegomer E-Si2330 in PM glycol ether were also added. Mixing was continued for about 12 hours.

Example 16: 4.1 g Polyvinylpyrrolidone K17, 77.28 g PM glycol ether were weighed out into a container and mixed for 1 hour until a homogeneous mixture was obtained. To this, 14.74 g of example 1A was added while mixing. 1.18 g water, 0.62 g glacial acetic acid, 0.17 g Ancamine K61B, 1.33 g Aerosol OT75, 0.38 g Schercoquat IAS-PG, 0.2 g of 10% Byk333 in PM glycol ether were also added. Mixing was continued for about 12 hours.

Example 17: 4.1 g Polyvinylpyrrolidone K90, 0.08 g Solsperse W430, 77.2 g PM glycol ether were weighed out into a container and mixed for 1 hour until a homogeneous mixture was obtained. To this, 14.74 g of example 1A was added while mixing. 1.18 g water, 0.62 g glacial acetic acid, 0.17 g Ancamine K61B, 1.33 g Aerosol OT75, 0.38 g Schercoquat IAS-PG, 0.2 g of 10% Byk333 in PM glycol ether were also added. Mixing was continued for about 12 hours.

Example 18: 4.1 g Polyvinylpyrrolidone K90, 0.08 g Disperbyk 2013, 77.2 g PM glycol ether were weighed out into a container and mixed for 1 hour until a homogeneous mixture was obtained. To this, 14.74 g of example 1A was added while mixing. 1.18 g water, 0.62 g glacial acetic acid, 0.17 g Ancamine K61B, 1.33 g Aerosol OT75, 0.38 g Schercoquat IAS-PG, 0.2 g of 10% Byk333 in PM glycol ether were also added. Mixing was continued for about 12 hours.

Example 19: 4.1 g Polyvinylpyrrolidone K90, 0.08 g Disperbyk 161, 77.2 g PM glycol ether were weighed out into a container and mixed for 1 hour until a homogeneous mixture was obtained. To this, 14.74 g of example 1A was added while mixing. 1.18 g water, 0.62 g glacial acetic acid, 0.17 g Ancamine K61B, 1.33 g Aerosol OT75, 0.38 g Schercoquat IAS-PG, 0.2 g of 10% Byk333 in PM glycol ether were also added. Mixing was continued for about 12 hours.

### Comparative Examples

Comparative Example 20: 4.1 g Polyvinylpyrrolidone K90, 0.08 g Solsperse W100, 77.48 g PM glycol ether were weighed out into a container and mixed for 1 hour until a homogeneous mixture was obtained. To this, 16.35 g of Denacol EX-614B was added while mixing. 0.17 g Ancamine K61B, 1.33 g Aerosol OT75, 0.38 g Schercoquat IAS-PG, 0.11 g of 10% Byk333 in PM glycol ether were also added. Mixing was continued for about 12 hours. This comparative example is analogous to examples 3-13 except it does not contain the urethane resin (only contains the isocyanate reactive compound having multi-epoxide functionality, but no isocyanate).

Comparative Example 21: 4.9 g Polyvinylpyrrolidone K90, 0.08 g Solsperse W100, 76.86 g PM glycol ether were weighed out into a container and mixed for 1 hour until a homogeneous mixture was obtained. To this, 12.98 g of Example 1 and 3 g of Dencaol EX-830 were added while mixing. 0.17 g Ancamine K61B, 1.48 g Aerosol OT75, 0.42 g Schercoquat IAS-PG, 0.11 g of 10% Byk333 in PM glycol ether were also added. Mixing was continued for about 12 hours. This comparative example is analogous to examples 3-13 except it contains urethane resin in a smaller amount (less amount of Example 1, with added difunctional epoxide Denacol EX-830).

Comparative Example 22: 4.9 g Polyvinylpyrrolidone K90, 0.08 g Solsperse W100, 76.86 g PM glycol ether were weighed out into a container and mixed for 1 hour until a homogeneous mixture was obtained. To this, 12.98 g of Example 1 and 3 g of PEG-600 were added while mixing. 0.17 g Ancamine K61B, 1.48 g Aerosol OT75, 0.42 g Schercoquat IAS-PG, 0.11 g of 10% Byk333 in PM glycol ether were also added. Mixing was continued for about 12 hours. This comparative example is analogous to examples 3-13 except it contains urethane resin in a smaller amount (less amount of Example 1, with added PEG-600).

Comparative Example 23: 71.55 g PM glycol ether and 24.51 g of Example 1 were weighed out into a container and mixed for 30 minutes until a homogeneous mixture was obtained. To this, 1.28 g water, 0.67 g glacial acetic acid were added and mixed for 1 hour. After 1 hour, 0.17 g Ancamine K61B, 1.34 g Aerosol OT75, 0.38 g Schercoquat IAS-PG, 0.1 g of 1% Tegomer E-Si2330 in PM glycol ether were also added. Mixing was continued for about 12 hours. This comparative example is analogous to examples 3-16 except it does not contain the water absorbent polymer.

Comparative Example 24: Visgard Premium SE, a commercially available coating from FSI Coating Technologies is used as is without any further modification.

Examples 1-19 and Comparative Examples 20-24 were all coated on identical Gentex polycarbonate lenses. All the coated parts were prepared by dip coating application in the same manner. The polycarbonate lenses (Gentex) were cleaned with soap and water, air dried prior to application of the coating. After dip coating, samples were air dried for one minute, precured at 90° C. for 10 minutes and cured at 120° C. for 2 hours.

### Test Methods

Unless otherwise indicated, all tests were performed at room temperature (about 18-23° C.).

Film Thickness: Film thickness of cured coating was measured with a Filmetrics F20-CP Spectrophotometer at wavelength of 632.8 nanometers (nm) based on spectral reflectance methodology.

Haze: Light transmission and light-scattering properties of the cured coating was evaluated by measuring haze according to ASTM D 1003 standard with a Haze-gard Plus (BYK-Gardner, Columbia, MD) hazemeter.

Adhesion: Adhesion is the ability of a coating to adhere to a substrate. The initial adhesion was tested using a roll of Nichiban #405 tape. The test was carried out as follows: 1) a cross-hatch of a 5×5 grid, approximately 2 mm apart was made with a retractable razor blade into the cured coating; 2) the tape was pressed down firmly (using a tongue depressor) over the cross-hatched area; 3) After 90 t 30 s, tape was pulled at an angle of 180° or as close to substrate as possible; 4) a check for the removal of the coating was made by examination of the coated substrate using appropriate visual control; 5) the subject area was also inspected under a microscope; 6) the actual count of unaffected areas was reported as percent adhesion (when adhesion was affected along a line only, the estimate is converted into percentages). This test is performed three times. If there is no coating loss after three pulls, the test is taken to be a “Pass.”

Initial Adhesion: When the adhesion is carried out on the coated lenses, as is, without any treatment, it is referred to as “Initial adhesion”.

Boiling Water Adhesion: Coated lenses are placed in boiling water at 100° C. for 1 hour. Lenses are removed, air dried for overnight and tested for adhesion as described above. This is referred to as “Boiling Water Adhesion.”

High Humidity Adhesion: This is an accelerated test for adhesion of a coating. Coated lenses are placed in humidity chamber (ESPEC Humidity Cabinet LH-113) for 10 days at 60° C., 90% RH. After 10 days, the samples are equilibrated in the room environment for 3-4 hours. Samples are tested for adhesion as described above. Samples are later placed in a water bath at 80° C. for 1 hour. This is followed by air drying the samples for 3-4 hours and testing for adhesion again. This is referred to as “High Humidity Adhesion—Initial/80 C, 1 h.”

K-mark (Abrasion Resistance to Fine Particles): The abrasion resistance to fine particles was tested according to the EN166/EN168 protocol. Coated lenses are equilibrated in a desiccator at 20° C., 30% RH for about 5 hours. The coated sample is loaded on a rotating holder in a Cadex Falling Sand tester. 3 kg of sand is loaded into a funnel that is 6 feet above the surface of the rotating article. After the full 3 kg of sand impinges the rotating articles surface, the article is removed and washed with soap and water. After washing, the article is blown dry with filtered compressed air. The sample is then loaded into a Cadex Light Diffusion measurement device. The light diffusion must be less than 5 cd/m²*lx to pass this test.

Coefficient of Friction: The surface smoothness of the cured coating is measured by coefficient of friction. Cheese cloth (obtained from Summers Optical meeting MIL CCC-C-440 specifications) is fixed to a sled of an Oakland Instruments Series 7000 Film Friction Tester. The sample to be tested is placed coated side down on the cheese cloth. A 200 g load is applied to the sample and connected to a load cell. The sled is then pulled horizontally away from the load cell applying friction between the sample and the cheese cloth. The load applied to the coated sample is recorded. The coefficient of friction (COF) is defined as: COF=Load cell reading/200 g; lower the coefficient of friction, smoother the surface. For reference, Visgard® Premium Plus, a premium commercial product of FSI Coatings Technologies has a measured coefficient of friction of 0.37. While a coefficient of friction value of 0.37 is considered to be “not so slick/smooth,” a coefficient of friction of less than 0.37, in accordance with the present disclosure is considered slick or smooth. Unless otherwise indicated herein, the coefficient of friction is measured on samples having a polycarbonate substrate.

Permanency of slickness: Coated samples are soaked in DI water for 7 hours. Samples were then dried overnight under room conditions. Coefficient of friction is measured on the dried samples. If the coefficient of friction is maintained, slickness is considered to be “permanent.”

Steel Wool Abrasion: Steel wool abrasion measured by YT-520 Steel Wool Tester gives qualitative determination of abrasion/scratch resistance of coated materials upon rubbing with standardized grades of steel wool. Japanese steel wool grade 0000 (Extra fine) was used for the test. The coated surface was rubbed by the machine in about 2″×2″ area for 10 strokes with a weight of 10 g. Surface was checked for number of scratches.

Bag Mark Off Test: Coated lens is placed in a LDPE bag and sandwiched between two uncoated lenses. A weight of 100 g is then placed over the top lens. The entire set up is placed in a humidity chamber at 30° C., 90% RH for 2 hours. After 2 hours, test sample is taken out of the bag and checked for any marks.

### Test Methods—Anti-Fog Properties

Breath Test: Breath test was carried out by holding the coated substrate about 2.5 to 7.5 cm from the tester. The tester blew on the sample so as to intentionally create fog. If no fog appeared on the coated substrate during the test, the coating composition passed the breath test. If fog appeared on the surface, then the coating composition failed this test.

Initial Anti-fog Test: Initial anti-fog test was carried out by positioning a coated substrate at a standard height (1″) above a beaker containing a source of 60° C. water. The coated substrate was exposed to water vapor from the 60° C. water for 1 minute. If fog appeared on the coated substrate during this test, the time taken for the appearance of the fog was recorded. If no fog appeared during 1 minute of exposure, then the coating was considered to “pass” the initial anti-fog test.

Manual Wipe Anti-fog Test: Coated sample is tested for anti-fog with water in a beaker at 60° C., for 10 seconds. If fog is not observed, sample is wiped with WypAll tissue wet with DI water. Sample is set aside for 1 minute and then tested for anti-fog again with 60° C. water for 10 s. On passing, sample is considered to have passed one wipe. In this manner test is repeated for at least 15 times or until the sample fails anti-fog test.

Machine Wipe Anti-fog Test: A wet lint-free cleanroom wipe is wetted and mounted onto a steel wool tester (YT-520 Steel Wool Tester). 100 g weight is applied to the tester. The coated lens is placed on the tester and wiped for 5 strokes. Coated sample is then rested for 1 minute and tested for anti-fog with water at 60° C. for 10 seconds. If there is no fog, test is “pass” for 1 cycle. Test sample is rested for 3 minutes and then retested. Tests are carried out for 10 cycles or until sample fails anti-fog test.

Water Soak Anti-fog Test: A coated substrate was soaked in water at room temperature for 1 hour. The coated specimen was then removed from the water, suspended on a rack at 25° C., 50% RH for 12 hours and tested for anti-fog property by placing the coated substrate above beaker containing water at 50° C. for 3 minutes. If fog appeared on the coated substrate during this test, the time taken for the appearance of the fog was recorded. If no fog appeared during 1 minute of exposure, then the coating was considered to “pass” the 1 hour water soak anti-fog test.

N-mark Anti-fog Test: In addition the anti-fog property of 12 hours conditioned water-soaked coated specimens was tested using a YT-810 Resistance to Fogging Tester (manufactured by Yin-Tsung Co., Ltd) according to the EN166/EN168 protocol. This procedure constitutes the N-mark test. The test involves placing the coated substrate onto the tester. When the test is started, the coated substrate is exposed to 50° C. steam, and a laser is passed through the lens. The amount of fogging was determined by reduction in the transmission of the laser light over 8 seconds of exposure. The coating fails the fog test if the laser transmission falls below 80% of the initial reading during the 8 seconds period; if not, it is rated as a pass.

2 h Water Soak N-mark Anti-fog Test: A coated substrate was soaked in water at room temperature for 2 hours. The coated specimen was then removed from the water, suspended on a rack at 25° C., 50% RH for 12-24 hours and tested for anti-fog property using a YT-810 Resistance to Fogging Tester (manufactured by Yin-Tsung Co., Ltd) according to the ISO 18526-3:2020 protocol. This procedure constitutes the 2 h Water Soak N-mark Anti-fog test. The test involves placing the coated substrate onto the YT-810 tester. When the test is started, the coated substrate is exposed to 50° C. steam, and a laser is passed through the lens. The amount of fogging was determined by reduction in the transmission of the laser light over 8 seconds of exposure. The coating fails the fog test if the laser transmission falls below 80% of the initial reading during the 8 seconds period; if not, it is rated as a pass.

Anti-frost test: A sample is placed into a freezer set at −18° C. for 1 hour. After 1 hour, the sample is removed to ambient conditions (20+/−5° C., 30-50% RH). The coated part is observed for 1 minute. If no frost is observed, the coating pass the Anti-Frost Test.

The measured properties of the examples are listed in Tables 1-3.

TABLE 1

| | Example | Example | Example | Example | Example | Example | Example | Example |
|---|---|---|---|---|---|---|---|---|
| | 3 | 4 | 5 | 6 | 7 | 8 | 9 | 10 |
| Thickness (um) | 6.9 | 6.5 | 7.1 | 6.72 | 9.8 | 12 | 5.2 | 7.7 |
| Haze | 1.54 | 0.34 | 0.24 | 0.17 | 0.17 | 0.17 | 0.23 | 0.15 |
| Slickness | Slick | Slick | Slick | Slick | Slick | Slick | Slick | Slick |
| Coefficient | 0.19 | 0.19 | 0.24 | 0.19 | 0.24 | 0.24 | 0.15 | 0.24 |
| of Friction | | | | | | | | |
| Initial adhesion | Pass | Pass | Pass | Pass | Pass | Pass | Pass | Pass |
| 100 C., 1 h, | Pass | Pass | Pass | Pass | Pass | Pass | Pass | Pass |
| adhesion | | | | | | | | |
| High humidity | Pass/Pass | Pass/Pass | Pass/Pass | Pass/Pass | Pass/Pass | Pass/Pass | Pass/Pass | Pass/Pass |
| Adhesion, | | | | | | | | |
| Init./80 C., 1 h | | | | | | | | |
| Initial Antifog, | Pass | Pass | Pass | Pass | Pass | Pass | Pass | Pass |
| 60 C., 3 min | | | | | | | | |
| Manual Wipes | Not | Pass | Pass | Pass | Pass | Pass | Pass | Pass |
| Anti-fog | tested | | | | | | | |
| (15 Wipes) | | | | | | | | |
| Machine Wipes | Not | Pass | Pass | Pass | Pass | Pass | Pass | Pass |
| Anti-fog | tested | | | | | | | |
| (10 cycles) | | | | | | | | |
| Water soak | Fail | Fail | Pass | Pass | Pass | Pass | Pass | Pass |
| Anti-fog | | | | | | | | |
| N Mark Anti-fog | Fail | Pass | Pass | Pass | Pass | Pass | Pass | Pass |
| 2 h Water | Fail | Fail | Pass | Pass | Pass | Pass | Pass | Pass |
| Soak N-mark | | | | | | | | |
| Anti-fog Test | | | | | | | | |
| Anti-Frost | Fail | Fail | Fail | Fail | Fail | Fail | Fail | Fail |
| Steel Wool | No | No | No | No | No | No | Many | Many |
| Abrasion | Scratches | Scratches | Scratches | Scratches | Scratches | Scratches | Scratches | Scratches |
| K Mark | Pass | Pass | Pass | Pass | Pass | Pass | Fail | Pass |
| Bag Mark-off | No Mark | No Mark | No Mark | No Mark | No Mark | No Mark | No Mark | No Mark |
| AR | Not | Pass | Not | Not | Not | Not | Pass | Not |
| compatibility | tested | | tested | tested | tested | tested | | tested |

TABLE 2

| | Example | Example | Example | Example | Example | Example | Example | Example | Example |
|---|---|---|---|---|---|---|---|---|---|
| | 11 | 12 | 13 | 14 | 15 | 16 | 17 | 18 | 19 |
| Thickness (um) | 5.8 | 8.5 | 6.7 | 9 | 3.3 | 1.3 | 4.8 | 4.8 | 4.9 |
| Haze | 0.15 | 0.3 | 0.6 | 0.48 | 0.23 | 3 | 11 | 3.9 | 10 |
| Slickness | Slick | Not so | Not so | Slick | Slick | Slick | Slick | Slick | Slick |
| | | slick | slick | | | | | | |
| Coefficient | 0.24 | 0.304 | 0.42 | 0.28 | 0.2 | 0.2 | 0.23 | 0.18 | 0.21 |
| of Friction | | | | | | | | | |
| Initial adhesion | Pass | Pass | Pass | Pass | Pass | Fail | Pass | Pass | Pass |
| 100 C., 1 h, | Pass | Pass | Pass | Pass | Pass | Fail | Fail | Fail | Fail |
| adhesion | | | | | | | | | |
| High humidity | Pass/Pass | Pass/Pass | Pass/Pass | Not | Not | Fail | Not | Not | Not |
| Adhesion, | | | | tested | tested | | tested | tested | tested |
| Init./80 C., 1 h | | | | | | | | | |
| Initial Antifog, | Pass | Pass | Pass | Pass | Pass | Pass | Pass | Pass | Pass |
| 60 C., 3 min | | | | | | | | | |
| Manual Wipes | Pass | Pass | Pass | Not | Not | Not | Not | Not | Not |
| Anti-fog | | | | tested | tested | tested | tested | tested | tested |
| (15 Wipes) | | | | | | | | | |
| Machine Wipes | Pass | Pass | Pass | Not | Not | Not | Not | Not | Not |
| Anti-fog | | | | tested | tested | tested | tested | tested | tested |
| (10 cycles) | | | | | | | | | |
| Water soak | Pass | Pass | Pass | Fail | Fail | Fail | Pass | Pass | Pass |
| Anti-fog | | | | | | | | | |
| N Mark Anti-fog | Pass | Pass | Pass | Fail | Fail | Fail | Not | Not | Not |
| | | | | | | | tested | tested | tested |
| 2 h Water | Pass | Not | Not | Not | Not | Not | Not | Not | Not |
| Soak N-mark | | Tested | Tested | Tested | Tested | Tested | Tested | Tested | Tested |
| Anti-fog Test | | | | | | | | | |
| Anti-Frost | Pass | Not | Not | Not | Not | Not | Not | Not | Not |
| | | tested | tested | tested | tested | tested | tested | tested | tested |
| Steel Wool | Many | Many | Many | Not | Not | Not | Not | Not | Not |
| Abrasion | scratches | scratches | scratches | tested | tested | tested | tested | tested | tested |
| K Mark | Fail | Pass | Fail | Not | Not | Not | Not | Not | Not |
| | | | | tested | tested | tested | tested | tested | tested |
| Bag Mark Off | No Mark | Not | Not | Not | Not | Not | Not | Not | Not |
| | | tested | tested | tested | tested | tested | tested | tested | tested |
| AR | Not | Not | Not | Not | Not | Not | Not | Not | Not |
| compatibility | tested | tested | tested | tested | tested | tested | tested | tested | tested |

TABLE 3

| | Comparative | Comparative | Comparative | Comparative | Comparative |
|---|---|---|---|---|---|
| | Example 20 | Example 21 | Example 22 | Example 23 | Example 24 |
| Thickness (um) | 8.13 | 13 | 7.73 | 1.12 | 4.9 |
| Haze | 0.96 | 26 | 2.64 | 0.2 | 0.2 |
| Slickness | Slick | Slick | Slick | Slick | Not slick |
| Coefficient of Friction | Not tested | 0.26 | 0.27 | 0.22 | 0.37 |
| Initial adhesion | Pass | Pass | Fail | Pass | Pass |
| 100 C., 1 h, adhesion | Fail | Pass | Fail | Pass | Pass |
| High humidity Adhesion, | Fail/Fail | Fail/Fail | Fail | Not tested | Pass |
| Init. /80 C., 1 h | | | | | |
| Initial Antifog, | Not tested | Pass | Pass | Pass | Pass |
| 60 C., 3 min | | | | | |
| Manual Wipes Anti-fog | Not tested | Not tested | Not tested | Not tested | Pass |
| (15 Wipes) | | | | | |
| Machine Wipes Anti-fog | Fail | Not tested | Not tested | Not tested | Pass |
| (10 cycles) | | | | | |
| Water soak Anti-fog | Not tested | Fail | Fail | Fail | Fail |
| N Mark Anti-fog | Not tested | Fail | Fail | Fail | Fail |
| 2 h Water Soak N-mark | Not Tested | Not Tested | Not Tested | Not Tested | Not Tested |
| Anti-fog Test | | | | | |
| Anti-Frost | Not tested | Not tested | Not tested | Not tested | Fail |
| Steel Wool Abrasion | Not tested | Not tested | Not tested | Not tested | No scratches |
| K Mark | Not tested | Not tested | Not tested | Not tested | Fail |
| Bag Mark Off | Not tested | Not tested | Not tested | Not tested | Leaves Mark |
| AR compatibility | Not tested | Not tested | Not tested | Not tested | Pass |

Examples 3-8 were prepared with siloxane containing urethane epoxide resins, while Examples 9-11 were prepared with non-silicon containing urethane epoxide resins. Examples 3-8 show comparatively higher abrasion resistance than Examples 9-11, possibly because the silicon component improves abrasion resistance of the coating.

Examples 3-15 pass the Boiling Water Adhesion Test (treatment by boiling water at 100° C. for 1 hour). Examples 16-19, on the other hand, have lower isocyanate content in the urethane resin and fail the Boiling Water Adhesion Test. The effect of the isocyanate is further exemplified in comparative example 20, which does not contain any isocyanate (and thus no urethane resin).

Results from Comparative Examples 21 and 22 indicate that the epoxide component also plays a role in adhesion. Both have the same amount of urethane resin component, but Comparative Example 21 includes additional epoxide component (Denacol EX-830, a difunctional epoxide) while Example 22 instead includes PEG-600 (polyethylene glycol 600). Comparative Example 21 shows better adhesion than Comparative Example 22.

Bag Mark Off Test is critical for evaluating the compatibility to multi packing solutions. Comparative Example 24 leaves a bag mark off when packed in a LDPE bag. In contrast, Examples 3-11 do not leave a bag mark off when packed in LDPE bags. Examples 3-11 also have low coefficient of friction and have a smooth surface feel.

All the tested examples passed the Initial Anti-fog Test. Additionally, Examples 5-13 pass the Water Soak Anti-fog Test (treatment by soaking in water for 1 hour). Examples 5-13 are considered to contain the suitable amount of water absorbent polymer (Polyvinylpyrrolidone K90) (in the range of 17.9-32.56 wt % based on total solid) and urethane resin (in the range of 59.8-73.43 wt % based on total solid). Examples 3, 4, and 15, and Comparative Example 23 have lower or zero amounts of Polyvinylpyrrolidone K90 and fail the Water Soak Anti-fog Test. Examples 14 and 16 respectively contain Polyvinylpyrrolidone K120 of molecular weight 3 million Dalton and Polyvinylpyrrolidone K17 of molecular weight 16000 Dalton as water absorbent polymers. Both Examples 14 and 16 performed poorly in the Water Soak Anti-fog Test. Comparative Example 20 does not contain urethane resin. Comparative Examples 21 and 22 contain urethane resin formed from different ingredients as compared to other examples. Each of Comparative Examples 20-22 failed the Water Soak Anti-fog Test, indicating that the nature of the urethane resin is also critical for passing the Water Soak Anti-fog Test.

Table 4 includes the test result for permanency of surface slickness of example 4.

TABLE 4

Coefficient of friction

| Sample | Initial | After 7 h water soak |
|---|---|---|
| Example 4 | 0.24 | 0.22 |

While the present disclosure describes exemplary aspects of compositions, articles, and methods in detail, the present disclosure is not intended to be limited to the disclosed aspects. Also, certain elements of exemplary aspects disclosed herein are not limited to any exemplary aspects, but instead apply to all aspects of the present disclosure.

The terminology as set forth herein is for description of the aspects of this disclosure only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, the phrase “at least one of A, B, and C” should be interpreted as “only A or only B or only C or any combinations thereof.”

The multi-part composition and the associated method of the present disclosure can comprise, consist of, or consist essentially of the essential elements of the disclosure as described herein, as well as any additional or optional element described herein or which is otherwise useful in preparing and applying hybrid epoxy resins.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

1. A coating composition comprising:
a. a urethane resin obtained by reaction of an isocyanate reactive compound having multi-epoxide functionality and an isocyanate;
b. a water absorbent polymer; and
c. a curing agent,
d. a solvent
wherein when applied to a substrate and thermally cured, the coating composition forms a transparent and smooth coating having permanent anti-fog property.

2. The coating composition of claim 1, wherein when the coated substrate is soaked in water for 1 h, equilibrated at 25° C., 50% RH for at least 12 h and tested for anti-fog with 50° C. water, it stays fog free for at least 8 s.

3. The coating composition of claim 1, wherein when the coated substrate is soaked in water for 2 h, equilibrated at 25° C., 50% RH for at least 12 h and tested for anti-fog with 50° C. water, it stays fog free for at least 8 s.

4. The coating composition of claim 1, wherein the coating has a coefficient of friction of lower than 0.37.

5. The coating composition of claim 1, wherein the isocyanate reactive compound having multi-epoxide functionality contains at least one hydroxyl group.

6. The coating composition of claim 1, wherein the isocyanate reactive compound having multi-epoxide functionality is ethoxylated.

7. The coating composition of claim 1, wherein the isocyanate reactive compound having multi-epoxide functionality is non-silicon containing.

8. The coating composition of claim 7, wherein the non-silicon containing isocyanate reactive compound having multi-epoxide functionality contains three or more epoxide groups.

9. The coating composition of claim 1, wherein the isocyanate reactive compound having multi-epoxide functionality is selected from aliphatic polyepoxide, glycerol polyglycidyl ether, polyglycerol polyglycidyl ether, sorbitol polyglycidyl ether, ethylene glycol diglycidyl ether, diethylene glycol diglycidyl ether, polyethylene glycol diglycidyl ether, polypropylene glycol diglycidyl ether, phenoxy (ethylene oxide)₅ glycidyl ether, and lauryloxy (ethylene oxide)₁₅ glycidyl ether, or a combination thereof.

10. The coating composition of claim 1, wherein the isocyanate comprises at least one silicon containing isocyanate.

11. The coating composition of claim 10, wherein the at least one silicon containing isocyanate has a general structure of NCO(R)Si(OR¹)₃, NCO(R)Si(OR¹)₂R³, NCO(R)Si(OR¹)(R³)₂, or combination thereof, where R=(CH₂)ₙ, n=1-6, R¹=CH₃ or C₂H₅, and R³=CₓH₂ₓ₊₁, x=1-4.

12. The coating composition of claim 1, wherein the isocyanate is non-silicon containing.

13. The coating composition of claim 1, wherein the isocyanate has an isocyanate functionality greater than 1.

14. The coating composition of claim 13, wherein the isocyanate is selected from isophorone diisocyanate (IPDI), hexamethylene diisocyanate (HDI), xylene diisocyanate (XDI), toluene diisocyanate (TDI), diphenylmethane diisocyanate, HDI biuret, a diisocyanate derived from the foregoing, or a combination thereof.

15. The coating composition of claim 1, wherein the water absorbent polymer is selected from polyvinylpyrrolidone, poly (vinylpyrrolidone-co-vinyl acetate), poly (vinylpyrrolidone-co-ethylacrylate), poly (viny-pyrrolidone-co-vinyl chloride), polyvinylalcohols, sulphonates esters, polyacrylic acid, or a combination thereof.

16. The coating composition of claim 1, wherein the curing agent is an amine, an amine salt, or a combination thereof.

17. The coating composition of claim 1, further comprising a polymeric dispersing agent with hydrophilic and hydrophobic segments.

18. The coating composition of claim 1, wherein when the substrate formed with the coating is placed at −18° C. for 1 hour, and then at 20±5° C. and 30-50% RH, no frost forms on the coating.

19. The coating composition of claim 1, wherein after the substrate formed with the coating is wiped for 10 cycles with a wet lint-free cleanroom wipe under 100 g weight for 5 strokes in each cycle, no fog forms on the coating for 10 seconds of exposure to 60° C. water vapor.

20. The coating composition of claim 1, wherein after soaking for 7 hours in deionized water, the coating has a coefficient of friction is retained between 0.1-0.37.

21. The coating composition of claim 1, wherein the coating is compatible with anti-reflective coating or mirror coating.

22. A coating composition comprising:
a. a urethane resin obtained by reaction of an isocyanate reactive compound having multi-epoxide functionality and an isocyanate;
b. a water absorbent polymer,
c. a curing agent;
d. a solvent; and a
e. dispersing agent

23. The coating composition of claim 22, wherein when applied to a substrate and thermally cured, the coating composition forms a transparent and smooth coating having permanent anti-fog property and/or anti-frost property.

24. An article comprising: a substrate, and a transparent, smooth, and permanent anti-fog coating disposed on the substrate,
wherein the coating is formed from a coating composition comprising a urethane resin, a water absorbent polymer, a curing agent, a dispersing agent, and a solvent,
wherein the urethane resin is a reaction product of an isocyanate reactive compound having multi-epoxide functionality and an isocyanate.

25. The article of claim 24, wherein when the coated substrate is soaked in water for 1 h, equilibrated at 25° C., 50% RH for at least 12 h and tested for anti-fog with 50° C. water, it stays fog free for at least 8 s.

26. The article of claim 24, wherein when the coated substrate is soaked in water for 2 h, equilibrated at 25° C., 50% RH for at least 12 h and tested for anti-fog with 50° C. water, it stays fog free for at least 8 s.

27. The article of claim 24, wherein the coating has a coefficient of friction of lower than 0.37.

28. The article of claim 24, wherein when the coated substrate is placed at −18° C. for 1 hour, and then at 20±5° C. and 30-50% RH, no frost forms on the coating.
